(19) United States
(12) Patent Application Publication
(10) Pub. No.: US 2023/0219041 A1
(43) Pub. Date: Jul. 13, 2023

(54) REVERSE OSMOSIS MEMBRANE PROCESSING METHOD

(71) Applicant: KURITA WATER INDUSTRIES LTD., Tokyo (JP)

(72) Inventor: Koichi NAGATA, Tokyo (JP)

(73) Assignee: KURITA WATER INDUSTRIES LTD., Tokyo (JP)

(21) Appl. No.: 17/927,734

(22) PCT Filed: Mar. 19, 2021
(86) PCT No.: PCT/JP2021/011424

§ 371 Date: Nov. 24, 2022

(30) Foreign Application Priority Data
May 28, 2020 (JP) 2020-093458

(51) Int. Cl. B01D 61/04; B01D 61/02; C02F 1/44; B01D 65/02; C02F 1/66

(52) U.S. Cl. CPC B01D 61/04; B01D 61/025; C02F 1/441; B01D 65/02; C02F 1/66; C02F 2303/16; C02F 2101/16

(57) ABSTRACT

This reverse osmosis membrane processing method comprises adjusting processing-target water to a pH range of 4 to 8 and passing the water through a reverse osmosis membrane device. The reverse osmosis membrane processing method is characterized in that alkaline water having a pH of 9.5 or higher is brought into contact intermittently with the reverse osmosis membrane of the reverse osmosis membrane device. Raw water may be preprocessed with active carbon, or the like, to serve as the processing-target water. If the processing-target water has a pH of 9.5 or higher, this processing-target water may be used as the alkaline water.

### TECHNICAL FIELD

The present invention relates to a reverse osmosis membrane processing method for processing processing-target water using a reverse osmosis membrane device (which may hereinafter be referred to as an RO device). Specifically, the present invention relates to a reverse osmosis membrane processing method for bringing highly alkaline water having a pH of 9.5 or higher into contact intermittently with an RO membrane device.

### BACKGROUND ART

In reverse osmosis membrane separation processing in which suspended matter, dissolved substances, or ions in processing-target water are separated using a reverse osmosis membrane (RO membrane), microorganisms included in processing-target water may proliferate inside device piping or on a membrane surface and form slime, resulting in a hindrance such as deterioration in amount of permeated water (flux).

In order to prevent such contamination of a permeable membrane due to microorganisms, methods, in which a disinfectant is constantly or intermittently added to processing-target water and membrane separation is performed while the processing-target water or the inside of a device is sterilized, are known. Generally, methods for sterilizing microorganisms by adding a chlorine-based oxidizing agent such as sodium hypochlorite as a disinfectant which is inexpensive and comparatively easy to handle are performed.

However, when a permeable membrane is a permeable membrane such as a polyamide-based polymer membrane having no chlorine resistance, addition of such a chlorine-based oxidizing agent may cause problems such as oxidative degradation in the permeable membrane due to free chlorine derived from the chlorine-based oxidizing agent and deterioration in removal rate.

In order to minimize such degradation in a permeable membrane, Japanese Patent Laid-Open No. H1-104310 and Japanese Patent Laid-Open No. H1-135506 disclose a method for generating chloramine (monochloramine or dichloramine) by adding ammonium ions after sterilization using free chlorine, and a method for adding a combined chlorine compound such as chloramine T or dichloramine T.

Japanese Patent Laid-Open No. 2006-263510 discloses a membrane separation method in which a combined chlorine agent consisting of a chlorine-based oxidizing agent and a sulfamic acid compound is caused to be present in feed water or cleaning water for a membrane separation device.

Japanese Patent Laid-Open No. 2005-81269 discloses a method for performing reverse osmosis membrane processing of organic matter-containing waste water, in which reverse osmosis membrane processing is performed after a pH is adjusted to 9.5 or higher by adding an alkali to organic matter-containing waste water and then the pH is adjusted to 4 to 8, in order to prevent deterioration in flux.

### CITATION LIST

### Patent Literature

### [Patent Literature 1]

Japanese Patent Laid-Open No. H1-104310

### [Patent Literature 2]

Japanese Patent Laid-Open No. H1-135506

### [Patent Literature 3]

Japanese Patent Laid-Open No. 2006-263510

### [Patent Literature 4]

Japanese Patent Laid-Open No. 2005-81269

When processing-target water containing ammonia is subjected to RO processing, if the processing-target water is caused to have a high pH, most of ammonia is present as non-ionic NH₄, and ammonia cannot be sufficiently removed by means of RO. For this reason, when high-pH processing-target water and containing ammonia is subjected to RO processing, the pH thereof is caused to be approximately 4 to 8 by adding an acid, and processing-target water is supplied to an RO device after a slime inhibitor (slime preventive agent) is added thereto in order to prevent membrane fouling.

Even if a slime inhibitor is added in this manner, membrane fouling proceeds over time in processing-target water having a high TOC concentration and a high biopotential due to generation of slime. Therefore, there is a need to perform membrane cleaning regularly or at the time of differential pressure rise. Regarding such cleaning, CIP cleaning using an alkaline agent is often performed.

If the frequency of this regular membrane cleaning is increased, cleaning chemical costs will rise. If the frequency of cleaning is reduced, membrane fouling will proceed. In addition, when membrane cleaning is performed upon detection of differential pressure rise in a membrane, a mechanism or an operation worker for detecting differential pressure and performing cleaning is required.

As above, in methods in the related art in which processing-target water containing ammonia and having a high TOC concentration is neutralized and RO processing is performed by adding a slime inhibitor, there are problems such as increase in cleaning chemical costs, necessity of CIP cleaning equipment, and increase in working personnel costs.

### SUMMARY OF INVENTION

### Technical Problem

An objective of the present invention is to provide a reverse osmosis membrane processing method in which the processing-target water can be efficiently processed at low cost while slime is inhibited.

### Solution to Problem

According to an aspect of the present invention, a reverse osmosis membrane processing method includes adjusting processing-target water to a pH range of 4 to 8, and passing the water through a reverse osmosis membrane device. The reverse osmosis membrane processing method is characterized in that alkaline water having a pH of 9.5 or higher is brought into contact intermittently with a reverse osmosis membrane of the reverse osmosis membrane device.

According to the aspect of the present invention, the processing-target water has a pH of 9.5 or higher, and the processing-target water having the pH of 9.5 or higher is used as the alkaline water.

According to the aspect of the present invention, the alkaline water is waste water from a different step within the same facility.

According to the aspect of the present invention, while a plurality of the reverse osmosis membrane devices is installed in parallel and alkaline water having a pH of 9.5 or higher is brought into contact with at least the reverse osmosis membrane of one reverse osmosis membrane device, reverse osmosis membrane processing is performed by causing processing-target water which has been adjusted to a pH of 4 to 8 to pass through a different reverse osmosis membrane device.

The aspect of the present invention further includes a step of obtaining the processing-target water and/or alkaline water by preprocessing raw water.

According to the aspect of the present invention, the preprocessing is active carbon processing.

According to the aspect of the present invention, an ammonia concentration of the processing-target water and/or alkaline water is 1 mg/L or higher.

According to the aspect of the present invention, a TOC concentration of the processing-target water is 0.5 mg/L or higher.

According to the aspect of the present invention, the step of bringing the alkaline water having the pH of 9.5 or higher into contact with the reverse osmosis membrane is performed with a frequency of once every 12 hours to once a month.

### Advantageous Effects of Invention

In the reverse osmosis membrane processing method of the present invention, since an RO membrane is cleaned using high-pH processing-target water or waste water from a different step, cleaning costs are low even if the frequency of cleaning is increased because it does not involve cleaning chemical costs for an RO membrane. In addition, fouling of an RO membrane can be sufficiently inhibited by increasing the frequency of cleaning.

According to the aspect of the present invention, since RO processing is performed after high-pH processing-target water is adjusted to have a pH of 4 to 8, ammonia can be sufficiently removed even when processing-target water contains ammonia.

### BRIEF DESCRIPTION OF DRAWINGS

FIG. 1 is a flowchart showing an example of a method of the present invention.

FIG. 2 is a flowchart showing another example of the method of the present invention.

### DESCRIPTION OF EMBODIMENT

According to an aspect of the present invention, processing-target water (raw water) having a pH of 9.5 or higher is adjusted to have a pH of 4 to 8, preferably 5 to 7, and then the water is caused to pass through a reverse osmosis membrane device (RO device). The present invention is suitable for processing processing-target water including ammonia, particularly processing-target water having a high ammonia concentration such as 1 mg/L or higher, specifically, 1 to 10,000 mg/L. Since ammonia is a weakly basic compound, ammonia-containing water having such a concentration normally has a pH of 9.5 or higher. In addition, it is suitable for processing processing-target water having a TOC concentration of 0.5 mg/L or higher, particularly 2 to 50 mg/L. Regarding such processing-target water, cleaning waste water and the like from a producing process in which a semiconductor is liquid crystal or the like can be exemplified, but it is not limited thereto. The upper limit for the pH of processing-target water is not particularly limited, but the pH is normally lower than 12.

In the present invention, processing-target water may be preprocessed using active carbon or the like. Through active carbon processing of processing-target water as preprocessing, degradation of an RO membrane can be prevented by removing ozone, peroxide, and the like. In addition, an effect of reducing a TOC load of an RO membrane is also exhibited by removing some organic matters (TOC components) in processing-target water. The means for preprocessing is not limited to active carbon processing, and one or more of biological processing using activated sludge or a floating carrier method; reduction processing of H₂O₂ using a chemical; turbidity removal processing using a turbidity removal filter, a filter device, or a turbidity removal membrane device; and the like may be employed.

In this manner, the pH is adjusted to 4 to 8, preferably 5 to 7 by adding an acid to processing-target water which has been subjected to preprocessing using active carbon or the like as necessary. In addition, after (before or at the same time as) this pH adjustment, a slime inhibitor is added thereto. Regarding an acid, sulfuric acid, hydrochloric acid, or the like can be used. Regarding a slime inhibitor, Patent Literature 1 to Patent Literature 3 described above disclose examples thereof, but others may be adopted. When an RO membrane has a low chlorine resistance, it is preferable to use a slime inhibitor other than chlorine-based oxidizing agents.

Processing-target water of which the pH has been adjusted and to which a slime inhibitor has been added is caused to pass through a filter as necessary, and the water is caused to pass through the RO device. Regarding a filter, a cartridge filter, an automatic backwash filter using a filter element, or the like can be used.

In this manner, since RO processing is performed after high-pH processing-target water is adjusted to have a pH of 4 to 8, ammonia can be sufficiently removed even when processing-target water contains ammonia.

After processing-target water is caused to pass through the RO device for a prescribed time, the RO membrane is cleaned with the processing-target water having a pH of 9.5 or higher. Regarding this processing-target water for membrane cleaning having a pH of 9.5 or higher, it is suitable to use raw water which has been subjected to suspended solid removal processing, and it is suitable to use the foregoing preprocessed water, particularly active carbon-processed water. The upper limit for the pH of processing-target water used for membrane cleaning is not particularly limited, but it is preferable to be lower than 12 in order to prevent degradation of the RO membrane. For this reason, when the pH of processing-target water exceeds 12, the pH can be within a range of 9.5 to 12 by appropriately adding an acid or the like.

When the RO membrane is cleaned, it is preferable that processing-target water having a pH of 9.5 or higher is introduced to the raw water side of the RO device, this introduction is stopped thereafter, and the state is maintained for a prescribed time (for example, two hours, particularly five hours as the preferable lower limit, and 24 hours, particularly 12 hours as the preferable upper limit). Since the pH of processing-target water which has been introduced for membrane cleaning is 9.5 or higher, slime which has adhered to a membrane surface or the like dissolves and is removed.

Thereafter, it is preferable to clean (rinse) the RO device using permeated water of the RO device, raw water adjusted to have a pH of 4 to 8, or other clean water, and then processing-target water having a pH of 4 to 8 is restarted to pass through the RO device (RO processing).

Since no alkaline chemical is used for membrane cleaning using this processing-target water having a pH of 9.5 or higher, it does not practically involve costs for chemicals (however, as necessary, a small amount of alkaline chemical may be added to processing-target water for membrane cleaning having a pH of 9.5 or higher). For this reason, even if membrane cleaning is performed with a high frequency, for example, approximately once every 12 hours to once a month, preferably once every 12 hours to a week, and specifically once every 12 hours to once every 60 hours, costs for chemicals become zero or noticeably low. In addition, this cleaning method does not require cleaning equipment as in membrane cleaning in the related art using an alkaline chemical, and thus cleaning equipment costs become noticeably low. Personnel costs for cleaning work also become zero or noticeably low. Moreover, since cleaning can be performed in a condition in which membrane contamination does not proceed by shortening cleaning intervals, cleaning can be effectively performed.

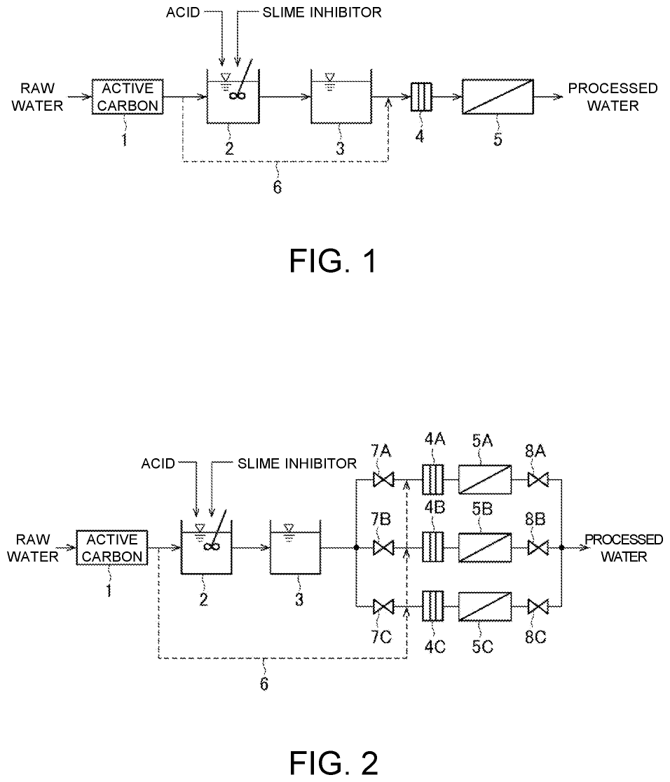

FIG. 1 shows an example of water processing equipment in which the foregoing cleaning method is applied.

Raw water is introduced into a reaction tank 2 via an active carbon column 1. The pH thereof is adjusted to 4 to 8 by adding an acid, and a slime inhibitor is added thereto. The active carbon column 1 may be a biological active carbon column. Water inside the reaction tank 2 is caused to pass through an RO device 5 via a relay tank 3, a filter 4, and a pump (not illustrated), and processed water is thereby obtained. Concentrated water is discharged through a concentrated water discharge line (not illustrated). In order to introduce outflow water from the active carbon column 1 into the RO device 5 (in this example, an upstream side of the filter 4), a bypass piping 6 is provided.

In FIG. 1, only one RO device 5 is installed, but a plurality of RO devices, for example, as in FIG. 2, three RO devices 5A, 5B, and 5C may be installed in parallel and operated in a merry-go-round system. Valves 7A to 7C and 8A to 8C are provided in front and behind the RO devices 5A to 5C.

When operation of a merry-go-round system is performed, for example, first, the RO devices 5A and 5B perform an RO processing step, and the RO device 5C performs a cleaning step. Specifically, the valves 7A, 7B, 8A, and 8B are opened, and processing-target water from the reaction tank 2 is caused to pass through the RO devices 5A and 5B. In addition, the valves 7C and 8C are closed, and outflow water from the active carbon column is introduced into the RO device 5C via a filter 4C, thereby performing the cleaning step. Before the outflow water from the active carbon column is introduced into the RO device 5C, first, it is preferable to provide a step of causing the outflow water from the active carbon column to pass through the filter 4C and discharging cleaning waste water of the filter 4C through a filter cleaning waste water discharging piping (not illustrated) of the filter 4C. It is possible to prevent recontamination of the RO device 5C due to contaminants which have adhered to the filter 4C by providing this step. After cleaning ends, the RO device 5C is cleaned (rinsed) with raw water which has been adjusted to have a pH of 4 to 8 by adding an acid in the reaction tank 2, and then the procedure returns to the RO processing step. The cleaning waste water is discharged out of the system through a cleaning waste water discharging piping (not illustrated) of the RO device 5C.

When the cleaning step is performed by the RO device 5A and the RO processing step is performed by the RO devices 5B and 5C, outflow water from the active carbon column is introduced into the RO device 5A, and processing-target water from the reaction tank 2 is caused to pass through the RO devices 5B and 5C. When the cleaning step is performed by the RO device 5B and the RO processing step is performed by the RO devices 5A and 5C, outflow water from the active carbon column is introduced into the RO device 5B, and processing-target water from the reaction tank 2 is caused to pass through the RO devices 5A and 5C.

The foregoing description is an example of the present invention, and the present invention may have a form other than those described above.

For example, FIG. 2 illustrates three RO devices, but two RO devices or four or more RO devices may be provided. In addition, in FIG. 2, the cleaning step is performed by one RO device, and the RO processing step is performed by other RO devices. However, when many RO devices are installed in parallel, the cleaning step may be performed by two or more RO devices, and the RO processing step may be performed by other RO devices.

In addition, in FIGS. 1 and 2, outflow water from the active carbon column is used in the cleaning step, but alkaline water having a pH of 9.5 or higher before being processed in the active carbon column 1 may be used in the cleaning step. However, since it is preferable that suspended matter, TOC components, and the like have the water quality equivalent to or higher than that of feed water of the RO device 5, it is preferable to perform preprocessing equivalent to that for feed water of the RO device 5 other than pH adjustment.

In addition, in FIG. 2, an active carbon column is used, but a means for preprocessing other than an active carbon column may be installed.

In the present invention, the alkaline water may be waste water from a different step within the same facility.

The present invention has been described in detail using particular forms, but it will be apparent to those skilled in the art that various changes can be made without departing from the idea and the scope of the present invention.

This application is based upon Japanese Patent Application No. 2020-093458, filed May 28, 2020, the entire content of which is incorporated herein by reference.

### REFERENCE SIGNS LIST

1 Active carbon column
2 Reaction tank
3 Relay tank
4, 4A to 4C Filter
5, 5A to 5C RO device

1. A reverse osmosis membrane processing method comprising:
adjusting processing-target water to a pH range of 4 to 8; and
passing the water through a reverse osmosis membrane device,
wherein the reverse osmosis membrane processing method further comprises that alkaline water having a pH of 9.5 or higher is brought into contact intermittently with a reverse osmosis membrane of the reverse osmosis membrane device.

2. The reverse osmosis membrane processing method according to claim 1,
wherein the processing-target water has a pH of 9.5 or higher, and the processing-target water having the pH of 9.5 or higher is used as the alkaline water.

3. The reverse osmosis membrane processing method according to claim 1,
wherein the alkaline water is waste water from a different step within the same facility.

4. The reverse osmosis membrane processing method according to claim 1,
wherein while a plurality of the reverse osmosis membrane devices is installed in parallel and alkaline water having a pH of 9.5 or higher is brought into contact with at least the reverse osmosis membrane of one reverse osmosis membrane device, reverse osmosis membrane processing is performed by causing processing-target water which has been adjusted to a pH of 4 to 8 to pass through a different reverse osmosis membrane device.

5. The reverse osmosis membrane processing method according to claim 1 further comprising:
a step of obtaining the processing-target water and/or alkaline water by preprocessing raw water.

6. The reverse osmosis membrane processing method according to claim 5,
wherein the preprocessing is active carbon processing.

7. The reverse osmosis membrane processing method according to claim 1,
wherein an ammonia concentration of the processing-target water and/or alkaline water is 1 mg/L or higher.

8. The reverse osmosis membrane processing method according to claim 1,
wherein a TOC concentration of the processing-target water is 0.5 mg/L or higher.

9. The reverse osmosis membrane processing method according to claim 1,
wherein the step of bringing the alkaline water having the pH of 9.5 or higher into contact with the reverse osmosis membrane is performed with a frequency of once every 12 hours to once a month.
